(19) United States
(12) Patent Application Publication
(10) Pub. No.: US 2022/0063336 A1
(43) Pub. Date: Mar. 3, 2022

(54) TRUCK TIRE

(71) Applicant: The Goodyear Tire & Rubber Company, Akron, OH (US)

(72) Inventors: Arun Prasath Manogaran, Everlange (LU); Robert Edward Lionetti, Bereldange (LU); Marco Nicolò Coccon, Luxembourg Ville (LU); Ettore Passante Spaccapietra, Ettelbruck (LU); Philippe Joseph Auguste Muller, Champlon (BE); Didier Winkin, Bastogne (BE); Vaibhav Nawale, Luxembourg (LU); Roland Willibrord Krier, Wasserbillig (LU)

(21) Appl. No.: 17/346,381

(22) Filed: Jun. 14, 2021

Related U.S. Application Data
(60) Provisional application No. 63/072,592, filed on Aug. 31, 2020.

(51) Int. Cl. B60C 9/20

(52) U.S. Cl. CPC B60C 9/20; B60C 2009/2019; B60C 2009/2016; B60C 2200/06

(57) ABSTRACT

A pneumatic tire for use on trucks, the tire comprising: a tread which includes a belt reinforcement structure, the belt structure including a pair of working belts, wherein the angle of the working belts range from about 12 degrees to about 36 degrees, wherein a low angle belt is positioned preferably between of the working belts, wherein the angle of the low angle belt is less than 5 degrees. The working belts and the low angle belt are extensible, and preferably made of extensible wire. The pneumatic tire further includes a top protector belt made of high impact resistant steel reinforcements.

### FIELD OF THE INVENTION

The invention relates in general to pneumatic tires, and more particularly for vehicles such as trucks.

### BACKGROUND OF THE INVENTION

The commercial truck market is moving towards an increase in overall vehicle weight, which is due in part to the increase in weight of the motor and equipment. The increase in overall vehicle weight requires a tire capable of handling the additional loading. Thus, a tire with improved crown durability and increased load carrying capacity is desired.

### SUMMARY OF THE INVENTION

The invention provides in a first aspect pneumatic tire for use on trucks, the tire comprising: a tread and a belt reinforcement structure located radially inward of the tread, the belt structure including a first and second working belt, wherein the angle of the first and second working belts range from about 12 degrees to about 36 degrees from the circumferential direction, wherein the first and second working belts are extensible, wherein the belt structure further comprises a low angle belt having reinforcements angled at less than 5 degrees, and wherein the low angle belt has extensible reinforcements.

### DEFINITIONS

“Aspect Ratio” means the ratio of a tire's section height to its section width.

“Axial” and “axially” mean the lines or directions that are parallel to the axis of rotation of the tire.

“Bead” or “Bead Core” mean generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Block element” means a tread element defined by a circumferential groove or shoulder and a pair of laterally extending grooves.

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions perpendicular to the axial direction within + or −5 degrees.

“Cord” means one of the reinforcement strands, including fibers, which are used to reinforce the plies.

“Extensible” means a cord having a relative elongation at break of greater than 0.2% at 10% of the breaking load, when measured from a cord extracted from a cured tire.

“Inner Liner” means the layer or layers of elastomer or other material that form the inside surface of a tubeless tire and that contain the inflating fluid within the tire.

“Inserts” means the reinforcement typically used to reinforce the side edges of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Rib” means a circumferentially extending strip of rubber of the tread which is defined by at least one circumferential groove and either a second circumferential groove or a lateral edge, wherein the strip is not divided by full depth grooves.

“Radial Ply Tire” means a belted or circumferentially-restricted pneumatic tire in which the ply cords which extend from bead to bead are laid at cord angles between 65° and 90° with respect to the equatorial plane of the tire.

“Side edge” means a portion of a tire between the tread and the bead.

“Sipe” means small slots or elongated void areas typically formed by thin steel blades, and which tend to remain closed, and function to increase traction.

“Laminate structure” means an unvulcanized structure made of one or more layers of tire or elastomer components such as the innerliner, side edges, and optional ply layer.

### BRIEF DESCRIPTION OF THE DRAWINGS

The invention will be described by way of example and with reference to the accompanying drawings in which:

FIG. 1 is a cross-sectional view of a first embodiment of a tire of the present invention; and

FIG. 2 is a close-up view of the belt package of the tire of FIG. 1.

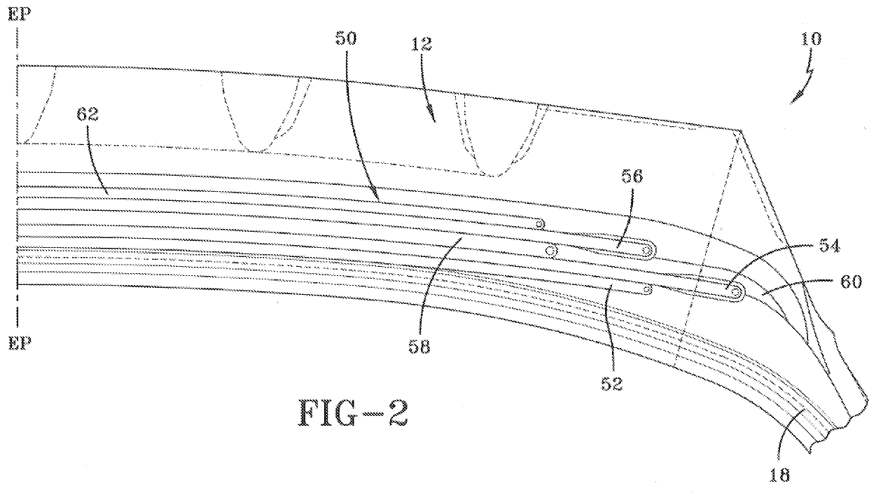

### DETAILED DESCRIPTION OF THE INVENTION

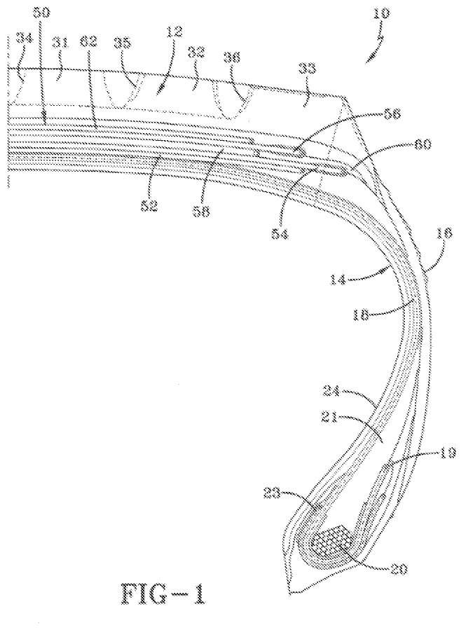

FIG. 1 illustrates a first embodiment of one half of a pneumatic tire 10, suitable for use as a truck tire. The tire 10 has a tread 12 with a non-skid depth D. The tire tread 12 may comprise a plurality of circumferentially continuous ribs, which may vary, but are shown for example as ribs 31, 32 and 33. Positioned between each rib is a circumferential groove 34, 35, 36, which are preferably continuous. The tread may also comprise optional sipes (not shown). The tread pattern is not limited to same, and may comprise, for example, a plurality of blocks and grooves (not shown).

The tire 10 further comprises a casing 14 which includes two opposed sidewalls 16 which extend down from the tread 12 to the bead area. The casing of the tire may optionally include an inner liner 24 which is typically formed of halobutyl rubber which forms an air impervious barrier. The tire casing 14 further includes one or more radial plies 18 extending from the tread, down the sidewall to the tire bead 20. Preferably the radial ply 18 is wrapped about or otherwise secured to each annular bead 20. In the embodiment illustrated and not limited to same, there is only one ply 18 and it is wrapped around the bead in an inside out manner such that the ply ending 19 is located axially outward and radially outwards of the bead. The beads 20 may be any desired shape, but in this embodiment, it is shown as a hexagonal configuration with steel filaments.

The tire may further optionally include an apex 21 which may be shaped like a triangle. The ply turnup in the bead area may be optionally reinforced with a chipper 23 wrapped about the bead ply 18.

The tire 10 further includes a belt package 50 which is located between the tread and the one or more plies 18. The belt package may be comprised of one or more layers of reinforcement. The ply 18 and the belt reinforcing structure 50 are made from cord reinforced elastomeric material, wherein the cords are typically steel wire or polyamide filaments and the elastomer preferably being rubber.

### Transition Belt 52

The belt reinforcing package 50 may include an optional transitional belt 52 that is the radially innermost belt of the belt package 50. The transition belt 52 has an axial belt width which may range from about 60% to about 90% of the tread arc width. The transition belt 52 preferably has an orientation that has an angle of between about 45 to about 70 degrees (right). The transition belt 52 is preferably made of ultra tensile steel with a construction of 3+2×0.35 UT.

### Working Belts 54,56

Belt reinforcing structure 50 further includes a first and second extensible working belt, 54, 56. First working belt 54 is located radially inwards of second working belt 56. Preferably, first working belt 54 has a belt width substantially equal to the tread arc width, and is preferably the widest belt of the belt package 50. The breaker angle of first working belt 54 is between about 12 and 36 degrees, preferably with a right orientation, more preferably in the range of about 14 to about 18 degrees or more preferably 30 to 34 degrees. First working belt 54 is made of extensible or high elongation wire, and has a % elongation at 10% of breaking load of greater than 0.2%, as measured from a cord taken from a cured tire. Preferably, the % elongation at the 10% of breaking load is greater than 0.4%, more preferably greater than 0.8%, and most preferably greater than 1.2%. The first working belt construction is preferably formed of wire having a wire construction of 3×7×, 3×4×, 4×4×. Preferably the wire has a construction of 4+3×, and more preferably, a wire construction of 4+3×0.35 UT. The EPI may range from about 8 to about 14.

The second working belt 56 is located radially outward of the first working belt, and preferably has a width less than the width of first working belt 54. Preferably, the second working belt 56 has a width less than the width of belt 54 by a step off, which may range from about 10 to about 20 mm. Working belt 56 has a breaker angle between about 16 and 30 degrees, preferably with a left orientation, more preferably in the range of about 19 to about 25 degrees. Second working belt 56 is preferably made of extensible or high elongation wire, having the same construction with the same but opposite angular orientation as the first working belt 54.

### Low Angle Belt 58

The belt structure 50 further comprises a low angle belt 58 which is preferably located between the working pair belts, 54, 56. The low angle belt 58 may also be located between belts 52 and 54 or radially outward of belt 56. The low angle belt 58 has reinforcements that are oriented circumferentially at 5 degrees or less, preferably 0 degrees. The belt is preferably formed from spirally winding a rubberized strip of one or more cords. Preferably the strip has about 1-4 steel cords. Alternatively, the belt may be formed of a cut belt with the reinforcements oriented in the range of 0 to about 10 degrees from the circumferential direction, or more preferably in the range of zero to five degrees from the circumferential direction. The low angle belt 58 has a width sized to avoid compression in the shoulder area. The belt width of low angle belt 58 is preferably less than the belt width of the first and second working belts. The belt structure of the low angle belt 58 may be steel formed of a 3×7 construction, a 3×4 construction, or a 4×4 construction. More preferably, the belt structure of the low angle belt 58 is steel formed of a 3×7×0.22 construction, a 3×4×0.26 construction, or a 4×4×0.22 construction, and preferably formed of high tensile steel. The reinforcement cords of the low angle belt 58 are preferably extensible. For measurements taken from bare cords, the % elongation at 10% of breaking load is 0.2 or more, and preferably 0.4% or more, and more preferably 0.6% or more, and most preferably 0.8%. Alternatively, the low angle belt may be formed of non-metal reinforcements such as aramid, carbon fiber, or polyketone or POK.

### Top Protection Belt

The belt structure may further include a top protector belt 62 that is the radially outermost belt. The top protector belt 62 has a width that is in the range of 80 to 85% of the width of the low angle belt. Preferably, the belt should have the same angle and orientation as the adjacent belt, 56. The top protector belt preferably has reinforcement cords made of high impact steel cord wherein the cord has full rubber penetration that helps in avoiding corrosion and enable excellent retreadability. It also provides high impact resistance as it exhibits more work to break because of its enhanced % elongation (>5%) even after embedded in rubber. Preferably, the reinforcement cords of the top protector belt have a cord construction of 5×, and more preferably, 5×0.35 or 5×0.38. The reinforcement cords are preferably made of steel, and are preferably high impact cords (HI), with a very high energy absorption with energy/cord >7.5 J/mm2, using a Charpy Impact Tester in a 1 inch strip with 10 EPI. Maximum compressive stresses of such cords are above 350 MPa at maximum deformation at kinking of >1.5%. Having a high-impact cord top protective belt helps in absorbing the shock created during an impact and relieves the stresses on the tread shoulder grooves.

The aspect ratio of the tire described above may vary. The aspect ratio is preferably in the range of about 50 to about 90. The tire may have a net to gross ratio in the range of about 70 to about 90, more preferably in the range of about 74 to about 86, more preferably about 78 to 84.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire for use on trucks, the tire comprising: a tread and a belt reinforcement structure located radially inward of the tread, the belt structure including a first and second working belts, wherein the angle of the first and second working belts range from about 12 degrees to about 36 degrees from the circumferential direction, wherein the belt structure further comprises a low angle belt having reinforcements angled at less than 5 degrees, and further including a top protector belt located radially outwards of the working belts, wherein the top protector belt is formed of reinforcement cords having an energy absorption of >7.5 J/mm2.

2. The tire of claim 1 wherein the low angle belt is located between the first and second working belts.

3. The tire of claim 1 wherein the working belts are formed of wire having a % elongation at 10% of breaking load greater than 0.2%, when taken from wire from a cured tire.

4. The tire of claim 1 wherein the working belts are formed of wire having a % elongation at 10% of breaking load greater than 0.4%, when taken from wire from a cured tire.

5. The tire of claim 1 wherein the first and second working belts are formed of wire having a % elongation at 10% of breaking load greater than 0.6%, when taken from wire from a cured tire.

6. The tire of claim 1 wherein the low angle belt is formed of wire having a % elongation at 10% of breaking load greater than 0.8%, when taken from wire from a cured tire.

7. The tire of claim 1 wherein the low angle belt is formed of wire having a % elongation at 10% of breaking load greater than 1.2%, when taken from wire from a cured tire.

8. The tire of claim 1 wherein the first working belt has a width about equal to the tread arc width.

9. The tire of claim 1 wherein first working belt has an axial width greater than the axial width of the low angle belt.

10. The tire of claim 1 wherein the second working belt has an axial width greater than the axial width of the low angle belt.

11. The tire of claim 1 wherein the first and second working belt have a wire construction of 4+3×0.35 UT.

12. The tire of claim 1 wherein the top protector belt has a 5× construction.

13. The tire of claim 1 wherein the top protector belt has a 5×0.35 HI construction.

14. The tire of claim 1 wherein the top protector belt has a 5×0.38 HI construction.

15. The tire of claim 1 wherein the first and second working belts have a 4+3× construction.

16. The tire of claim 1 wherein the low angle belt has a 3×7 construction.

17. The tire of claim 1 wherein the low angle belt has a 3×4 construction.

18. The tire of claim 1 wherein the low angle belt has a 4×4 construction.

19. The tire of claim 1 wherein the low angle belt has a 3×6 construction.

20. The tire of claim 1 wherein the low angle belt has a 4×4×0.22 HT HE construction.
